(19) United States
(12) Patent Application Publication
(10) Pub. No.: US 2008/0180572 A1
(43) Pub. Date: Jul. 31, 2008

(54) Enabling access to closed captioning data present in a broadcast stream

(75) Inventors: Shawn E. Pickett, Raleigh, NC (US); Edward Goziker, Redmond, WA (US); Ross F. Hewit, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/699,702

(22) Filed: Jan. 29, 2007

(51) Int. Cl. H04N 7/00; H04N 7/173

(52) U.S. Cl. 348/468; 348/465; 725/110; 725/136; 348/E07.001

(57) ABSTRACT

A system and method for enabling access to closed captioning data present in a broadcast stream is disclosed. The technology includes a method for enabling access to closed captioning data present in a broadcast stream. The method includes accessing device data associated with a broadcast stream receiver, wherein the device data indicates whether the broadcast stream receiver is configured to receive a digitized format of closed captioning data or an analog format of closed captioning data. Provided the digitized format of the closed captioning data is not present in the broadcast stream, the method includes ensuring the broadcast stream receiver is configured to access the analog format of the closed captioning data.

### BACKGROUND

In many countries, captioning data is required by law to be included in broadcast signals for the benefit of deaf persons and persons having difficulty hearing. In addition, closed captioning is widely used by persons watching broadcasting in a language that may not be their native language. The captioning data is used to provide a text description (although not always verbatim) of what is being said or what is happening.

Captions can be placed on a video signal in one of two ways, either live or offline using post-production techniques. Examples of live captioning include but are not limited to captioning provided in conjunction with live television news shows and live sporting events. Examples of offline captioning include but are not limited to captioning provided in conjunction with pre-recorded game shows and movies stored on digital video disks (DVDs).

There are a number of captioning formats that can be used to provide text descriptions to viewers. For example, closed captions are captions that are hidden in the broadcast signal and are invisible to the viewer without a special decoder. In addition to requiring a special decoder, a user may need to enable captioning on their television or broadcast receiver to view the closed captions.

Another format of captioning data is open captioning. Open captions are captions that are not encoded and are actually integral to the picture. For example, most subtitles in foreign movies are considered open captions. Unlike closed captions, open captions can not be hidden or disabled.

Often, captioning is split into multiple fields of data. For example, each field may provide captioning information in a different language to accommodate a greater viewing audience. In this case, a viewer may be required to specify a preferred language format of the captioning data on their broadcast receiver to access a particular version of the captioning data.

The various formats of captioning can lead to complications in accessing the caption information.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system and method for enabling access to closed captioning data present in a broadcast stream is disclosed. The technology includes a method for enabling access to closed captioning data present in a broadcast stream. The method includes accessing device data associated with a broadcast stream receiver, wherein the device data indicates whether the broadcast stream receiver is configured to receive a digitized format of closed captioning data or an analog format of closed captioning data. Provided the digitized format of the closed captioning data is not present in the broadcast stream, the method includes ensuring the broadcast stream receiver is configured to access the analog format of the closed captioning data.

In order to facilitate enabling access to closed captioning data present in a broadcast stream, a closed captioning preference monitor is used to ensure that the broadcast receiver is configured correctly to access the closed captioning data present in a broadcast signal. In one embodiment, the broadcast receiver is automatically configured to access closed captioning data present in a broadcast stream without requiring user manipulation of device settings.

### DESCRIPTION OF THE DRAWINGS

The accompanying drawings, which are incorporated in and form a part of this specification, illustrate embodiments of the technology for enabling access to closed caption data present in a broadcast stream and, together with the description, serve to explain principles discussed below:

FIG. 1 is a diagram of an exemplary computer system used in accordance with embodiments of the present technology for enabling access to closed captioning data present in a broadcast stream.

FIG. 2 is a diagram of an exemplary system for receiving a broadcast signal in accordance with embodiments of the present technology for enabling access to closed captioning data present in a broadcast stream.

FIG. 3 is a block diagram of an exemplary closed captioning access analyzer in accordance with embodiments of the present technology for enabling access to closed captioning data present in a broadcast stream.

FIG. 4 is an illustration of an exemplary display device with closed caption data displayed in accordance with embodiments of the present technology for enabling access to closed captioning data present in a broadcast stream.

FIG. 5 is a flow diagram of an exemplary method for enabling access to closed captioning data in accordance with embodiments of the present technology for enabling access to closed captioning data present in a broadcast stream.

The drawings referred to in this description should be understood as not being drawn to scale except if specifically noted.

### DETAILED DESCRIPTION

Reference will now be made in detail to embodiments of the present technology for enabling access to closed caption data present in a broadcast stream, examples of which are illustrated in the accompanying drawings. While the technology for enabling access to closed caption data present in a broadcast stream will be described in conjunction with various embodiments, it will be understood that they are not intended to limit the present technology for enabling access to closed caption data present in a broadcast stream to these embodiments. On the contrary, the presented technology for enabling access to closed caption data present in a broadcast stream is intended to cover alternatives, modifications and equivalents, which may be included within the spirit and scope the various embodiments as defined by the appended claims.

Furthermore, in the following detailed description, numerous specific details are set forth in order to provide a thorough understanding of the present technology for enabling access to closed caption data present in a broadcast stream. However, the present technology for enabling access to closed caption data present in a broadcast stream may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “receiving”, “performing”, “generating”, “displaying”, “selecting”, “scrolling”, “highlighting”, “presenting”, “configuring”, “identifying”, “reporting”, “ensuring”, “suppressing”, “providing”, and “accessing” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology for enabling access to closed caption data present in a broadcast stream is also well suited to the use of other computer systems such as, for example, optical and mechanical computers. Additionally, it should be understood that in embodiments of the present technology for enabling access to closed caption data present in a broadcast stream, one or more of the steps can be performed manually.

### Example Computer System Environment

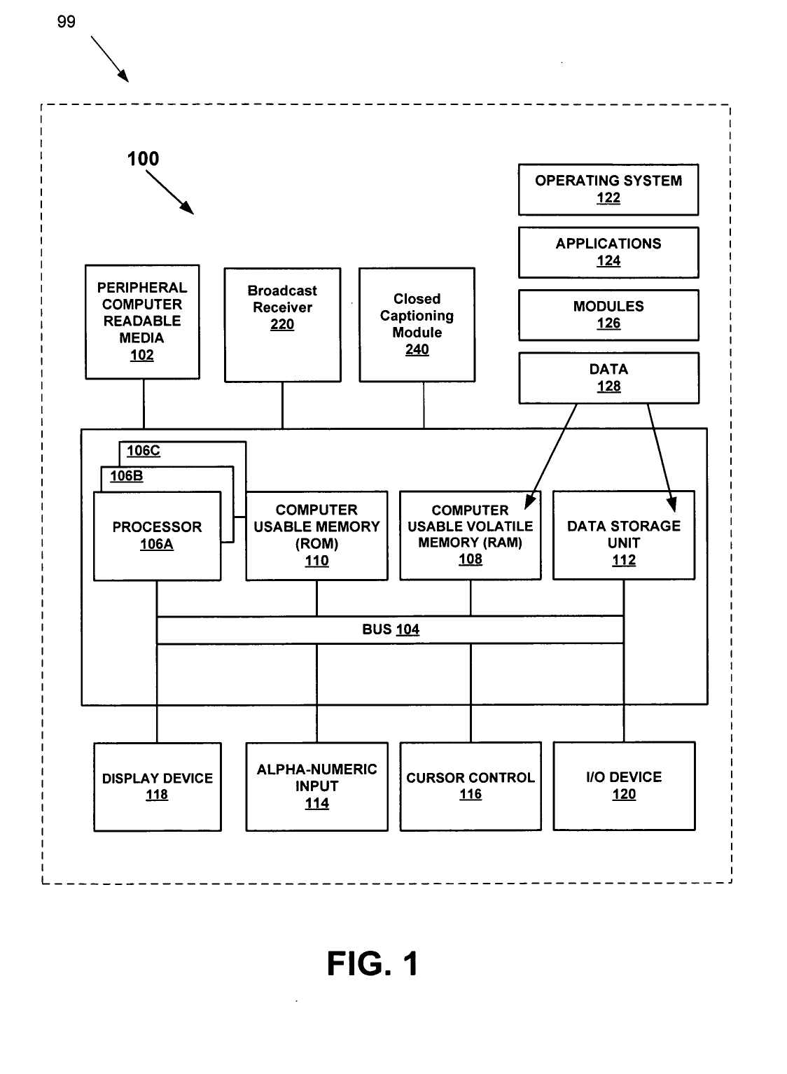

With reference now to FIG. 1, portions of the technology for enabling access to closed caption data present in a broadcast stream are composed of computer-readable and computer-executable instructions that reside, for example, in computer-usable media of a computer system. That is, FIG. 1 illustrates one example of a type of computer that can be used to implement embodiments, which are discussed below, of the present technology for enabling access to closed caption data present in a broadcast stream.

It is appreciated that computer system 100 could reside within or be coupled with device 99 which could be a television set, a television set top box, an Internet Protocol television device, a terrestrial broadcast receiver, a cable receiver or any other device capable of receiving a broadcast signal.

FIG. 1 illustrates an exemplary computer system 100 used in accordance with embodiments of the present technology for enabling access to closed caption data present in a broadcast stream. It is appreciated that system 100 of FIG. 1 is exemplary only and that the present technology for enabling access to closed caption data present in a broadcast stream can operate on or within a number of different computer systems including general purpose networked computer systems, embedded computer systems, routers, switches, server devices, consumer devices, various intermediate devices/artifacts, stand alone computer systems, and the like. As shown in FIG. 1, computer system 100 of FIG. 1 is well adapted to having peripheral computer readable media 102 such as, for example, a floppy disk, a compact disc, and the like coupled thereto.

Computer system 100 of FIG. 1 is well adapted to having or be coupled with a broadcast receiver 220. Broadcast receiver 220 can receive any type of broadcast signal including but not limited to a wireless terrestrial broadcast signal, a satellite wireless broadcast signal, a wired broadcast signal and an Internet Protocol television signal. Computer system 100 is also well adapted to having or be coupled with a closed captioning module 240 for enabling access to closed captioning data present in the broadcast stream received by broadcast receiver 220. It is appreciated that closed captioning module 240 can access analog formats and digitized formats of closed captioning and any other format of closed captioning in accordance with embodiments of the present technology.

System 100 of FIG. 1 includes an address/data bus 104 for communicating information, and a processor 106A coupled to bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 also includes data storage features such as a computer usable volatile memory 108, e.g. random access memory (RAM), coupled to bus 104 for storing information and instructions for processors 106A, 106B, and 106C.

System 100 also includes computer usable non-volatile memory 110, e.g. read only memory (ROM), coupled to bus 104 for storing static information and instructions for processors 106A, 106B, and 106C. Also present in system 100 is a data storage unit 112 (e.g., a magnetic or optical disk and disk drive) coupled to bus 104 for storing information and instructions. System 100 also includes an optional alphanumeric input device 114 including alphanumeric and function keys coupled to bus 104 for communicating information and command selections to processor 106A or processors 106A, 106B, and 106C. System 100 also includes an optional cursor control device 116 coupled to bus 104 for communicating user input information and command selections to processor 106A or processors 106A, 106B, and 106C. System 100 of the present embodiment also includes an optional display device 118 coupled to bus 104 for displaying information.

Referring still to FIG. 1, optional display device 118 of FIG. 1 may be a liquid crystal device, cathode ray tube, plasma display device or other display device suitable for creating graphic images and alphanumeric characters recognizable to a user. Optional cursor control device 116 allows the computer user to dynamically signal the movement of a visible symbol (cursor) on a display screen of display device 118. Many implementations of cursor control device 116 are known in the art including a trackball, mouse, touch pad, joystick or special keys on alpha-numeric input device 114 capable of signaling movement of a given direction or manner of displacement. Alternatively, it will be appreciated that a cursor can be directed and/or activated via input from alpha-numeric input device 114 using special keys and key sequence commands.

System 100 is also well suited to having a cursor directed by other means such as, for example, voice commands. System 100 also includes an I/O device 120 for coupling system 100 with external entities. For example, in one embodiment, I/O device 120 is a modem for enabling wired or wireless communications between system 100 and an external network such as, but not limited to, the Internet. A more detailed discussion of the present technology for enabling access to closed caption data present in a broadcast stream is found below.

Referring still to FIG. 1, various other components are depicted for system 100. Specifically, when present, an operating system 122, applications 124, modules 126, and data 128 are shown as typically residing in one or some combination of computer usable volatile memory 108, e.g. random access memory (RAM), and data storage unit 112. In one embodiment, the present technology for enabling access to closed caption data present in a broadcast stream, for example, is stored as an application 124 or module 126 in memory locations within RAM 108 and memory areas within data storage unit 112.

The computing system 100 is only one example of a suitable computing environment and is not intended to suggest any limitation as to the scope of use or functionality of the present technology. Neither should the computing environment 100 be interpreted as having any dependency or requirement relating to any one or combination of components illustrated in the exemplary computing system 100.

The present technology is operational with numerous other general-purpose or special-purpose computing system environments or configurations. Examples of well known computing systems, environments, and configurations that may be suitable for use with the present technology include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

### Overview

As an overview, in one embodiment, the present technology provides a method and system for enabling access to closed caption data present in a broadcast stream. In order to facilitate enabling access to closed captioning data present in a broadcast stream, a closed captioning preference monitor is used to ensure that the broadcast receiver is configured correctly to access the closed captioning data present in a broadcast signal. In one embodiment, the broadcast receiver is automatically configured to access closed captioning data present in a broadcast stream without requiring user manipulation of device settings.

The national television standards committee (NTSC) has developed standards for television broadcasting that is used in the United States and other countries. According to the NTSC broadcasting standards, closed captioning information must be included in analog broadcasts at line 21 of the vertical blanking interval (VBI) for analog broadcast transmissions. The analog format of closed captioning specified by the NTSC is the EIA-608 standard that was developed by the Electronic Industries Alliance. Closed captioning information is also required to be included in digital broadcast signals. However, due to increased bandwidth of digital broadcasting over analog broadcasting, an enhanced digitized captioning standard can provided with digital broadcast. For example, the EIA-708 digitized format of closed captioning developed by the Electronic Industries Alliance allows users to customize the appearance and other characteristics of the captioning at home.

The terms 608 format and 708 format are Federal Communications Commission terms and it is appreciated that various other terms may be used to describe analog and digitized closed captioning data in accordance with embodiments of the present technology. For clarity, the analog format of closed captioning has been assigned the reference number 608 and the digitized format of closed captioning has been assigned the reference number 708.

Currently, more than one format of captioning data can be present in television broadcast signals. As stated above, the 608 format of closed captioning is designed for analog broadcast signals and the 708 format of closed captioning is designed for digital broadcast signals. Analog broadcast signals usually include the 608 analog formatted captioning data, as sometimes required by law. However, digital broadcast signals may have analog formatted captioning data, digitized captioning data or both.

It is appreciated that the present technology for enabling access to closed captioning data present in a broadcast stream are well suited to be used in conjunction with many broadcasting types. For example, the present technology is well suited to be used with terrestrial broadcasting, cable broadcasting, over the Internet broadcasting, or any other type of wired or wireless broadcasting.

When closed captioning is enabled, most analog broadcast receivers are configured to receive only an analog form of closed captioning data while most digital broadcast receivers have the option of receiving both the analog format of the closed captioning data and a digitized format of the closed captioning data. Consequently, if the broadcast receiver is set to a format of closed captioning that is not present in the broadcast stream, the information will not be provided to the viewer. Embodiments of the present technology ensure that the broadcast receiver is configured to access whichever format of the closed captioning data is provided in the broadcast stream.

For example, in the case of the digital broadcast receiver, if the device is pre-set to receive a digitized 708 format of the closed captioning data and only an analog 608 format is provided in the broadcast, the present technology recognizes that only an analog format of the closed captioning is available and automatically configures the receiver to access the analog format of the closed captioning. In one embodiment, the present technology overrides the preset device configurations and reconfigures the broadcast receiver to access the format of closed captioning data that is provided in the broadcast signal.

In one embodiment, a captioning service descriptor carries information about closed captioning services found in the broadcast stream. For example, the captioning service descriptor can include data such as language formats of closed captioning available and whether the closed captioning is in an analog format or a digitized format. In one embodiment, the captioning service descriptor is part of the broadcast signal and is used to determine which format of closed captioning is provided in the broadcast signal.

In one embodiment, the present technology continues to monitor the broadcast signal for the digital format of the closed captioning data and re-configures the broadcast receiver to access the digitized format of the closed captioning data in response to detecting the digitized format of the closed captioning data is present in the broadcast stream.

Embodiments of the present technology provide a seamless closed captioning user experience even in the case where different formats of closed captioning data are present in a broadcast stream and in the case where the format of available closed captioning changes. Embodiments of the present technology for enabling access to closed captioning data present in a broadcast stream eliminate the burden off manually configuring the broadcast receiver to the correct closed captioning format provided in the broadcast signal. The present technology allows the user to enjoy a seamless viewing experience without requiring knowledge of how to configure the broadcast receiving device in the case where there is a mismatch between the broadcast receiver settings and what is provided in the broadcast.

### Architecture

Embodiments of the present technology for ensuring access to closed captioning data present in a broadcast stream are directed towards automatically configuring a broadcast receiver based on the information present in the broadcast stream.

In many countries, closed captioning information is required to be included in a broadcast signal. In some cases, only an analog format of the closed captioning data is present and/or required. The national television standards committee (NTSC) has developed standards for television broadcasting that is used in the United States and other countries. According to the NTSC broadcasting standards, closed captioning information must be included in analog broadcasts at line 21 of the vertical blanking interval (VBI). The analog format of closed captioning specified by the NTSC is the EIA-608 standard that was developed by the Electronic Industries Alliance.

Closed captioning information is also required to be included in digital broadcast signals. However, due to increased bandwidth of digital broadcasting over analog broadcasting, an enhanced digitized captioning standard can provided with digital broadcast. For example, the EIA-708 digitized format of closed captioning developed by the Electronic Industries Alliance allows users to customize the appearance and other characteristics of the captioning at home. Most digital broadcast signals include both the 608 analog format and the 708 digitized format. However, in some cases, only the 608 analog format is provided in the broadcast.

It is appreciated that embodiments of the present technology for ensuring access to closed captioning information in a broadcast signal can be used in conjunction with many different closed captioning formats and/or broadcasting standards and are not limited by the examples provided below. The analog 608 format and the digitized 708 format of closed captioning are used as examples only and are not intended to limit the scope of the present technology for ensuring access to closed captioning information included in a broadcast signal in any way.

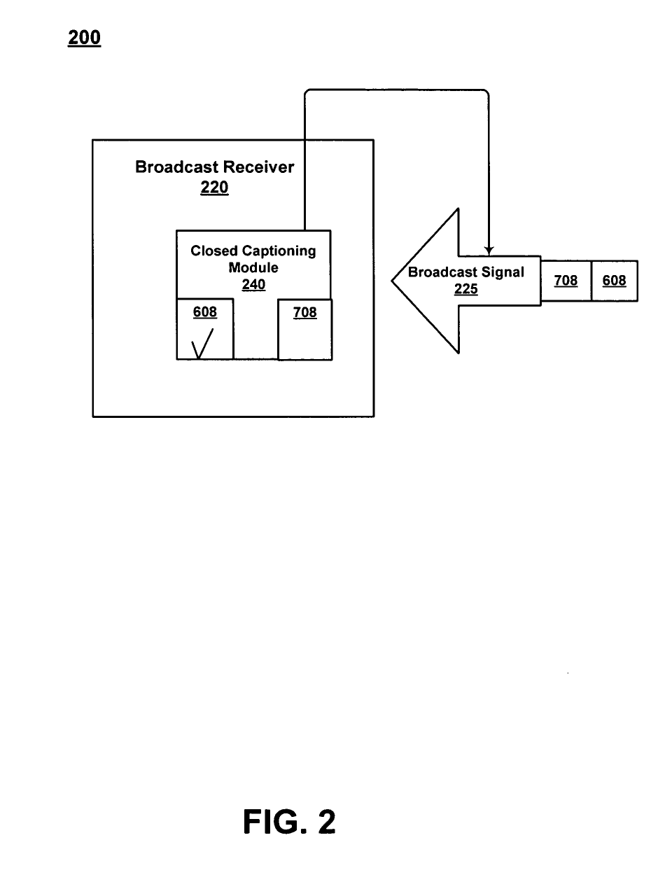

FIG. 2 is a block diagram of an exemplary system 200 for ensuring access to closed captioning data in accordance with embodiments of the present technology. A broadcast receiver 220 accesses a broadcast signal 225 that may include an analog format of closed captioning data 608 and/or a digitized format of closed captioning data 708. It is appreciated that the broadcast receiver may be a set top box, a cable box, a television set, a computer device or any other device configured to access a broadcast signal. A closed captioning module 240 coupled to the broadcast receiver ensures that the broadcast receiver 220 is configured to access the proper closed captioning format based on the type of closed captioning data is present in the broadcast stream 225.

For example, if the broadcast signal 225 includes the analog format of the closed captioning data 608, the closed captioning module 240 would ensure that the broadcast receiver 220 was configured to access the analog format of the closed captioning data 608. If the broadcast signal 225 includes the analog format of the closed captioning data 608 and the broadcast receiver 220 is configured to access the digitized format of the closed captioning data 708, the closed captioning module 240 automatically configures the broadcast receiver 220 to access the analog format of the closed captioning data 608.

In one embodiment, after ensuring the broadcast receiver is configured to access the analog format of the closed captioning data 608, the closed captioning module 240 periodically checks the broadcast stream 225 for the digitized format of the closed captioning data 708. In one embodiment, in response to detecting that the digitized format of the closed captioning data 708 is available, the closed captioning module 240 ensures that the broadcast receiver 220 is configured to access the digitized format of the closed captioning data 708.

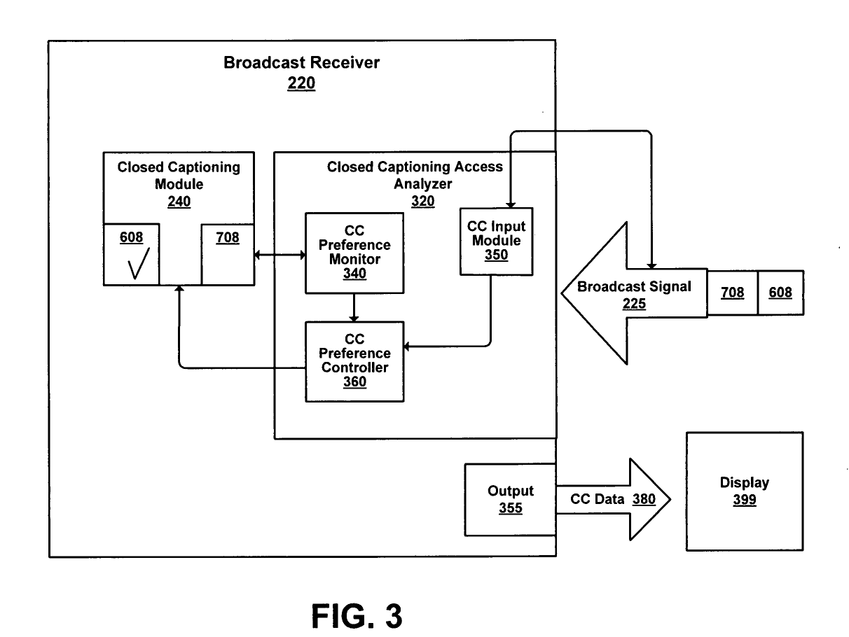

FIG. 3 is a block diagram of an exemplary closed captioning access analyzer 320 for ensuring access to closed captioning data present in a broadcast signal 225 in accordance with embodiments of the present technology. In one embodiment, the closed captioning (CC) access analyzer 320 includes a closed captioning preference monitor 340 for accessing device data associated with the broadcast receiver 220. The device data indicated whether the broadcast receiver is configured to receive a digitized 708 or analog 608 format of closed captioning data. In one embodiment, the broadcast receiver is set to either the 608 format or the 708 format. However, it is appreciated that the broadcast receiver could have any number of format options that can be selected.

The closed captioning access analyzer 320 further includes a closed captioning input module 350 for accessing the broadcast signal 225 and for determining which format of the closed captioning data is present in the broadcast stream 225. A closed captioning preference controller 360 receives the device data from the closed captioning preference monitor 340 and receives the closed captioning format information from the closed captioning input module 350.

The closed captioning preference controller 360 automatically toggles between the analog format 608 preference and the digitized format 708 preference based on which format is provided in the broadcast. In one embodiment, the closed captioning module 350 periodically monitors the broadcast signal 225 for changes in the closed captioning format provided.

For example, even when the digitized 708 format is available, commercials may only have analog 608 closed captioning data. In this case, the present technology would recognize that the digitized 708 format is not available and would configure the broadcast receiver to access the analog 608 closed captioning data. When the commercials are over, and the digitized format is available again, the present technology would configure the broadcast receiver to access the digitized 708 format.

In the case the broadcast signal 225 includes both the analog format 608 of the closed captioning and the digitized format 708 of the closed captioning, the closed captioning preference controller 360 ensures the broadcast receiver 220 is configured to access the digitized 708 format. However, if the digitized format 708 is not available, the closed captioning preference controller 360 configures the broadcast receiver 220 to receive the analog format 608 of the closed captioning data.

The closed captioning access analyzer 320 ensures the broadcast receiver 220 is correctly configured to access the closed captioning data provided in the broadcast signal 225. In one embodiment, a display device 399 is coupled to the broadcast receiver 225. The correct closed captioning data 380 is provided to the display device 399 by the output 355. The display 399 displays the correct closed captioning data 380.

In one embodiment, closed captions are provided in a plurality of languages. This is especially true when using the digitized 708 format of closed captioning. In one embodiment, the present technology recognizes a default or preferred language setting associated with the broadcast receiver and attempts to deliver the closed captioning information in the preferred language format, if it is available. If the language is not available, closed captioning in the native language of the broadcast can be provided.

It is appreciated that many broadcast signals are recorded for later viewing. Embodiments of the present technology are well suited to be used in conjunction with live broadcasting and/or recorded broadcasts to enable access to closed captioning data provided in a broadcast signal.

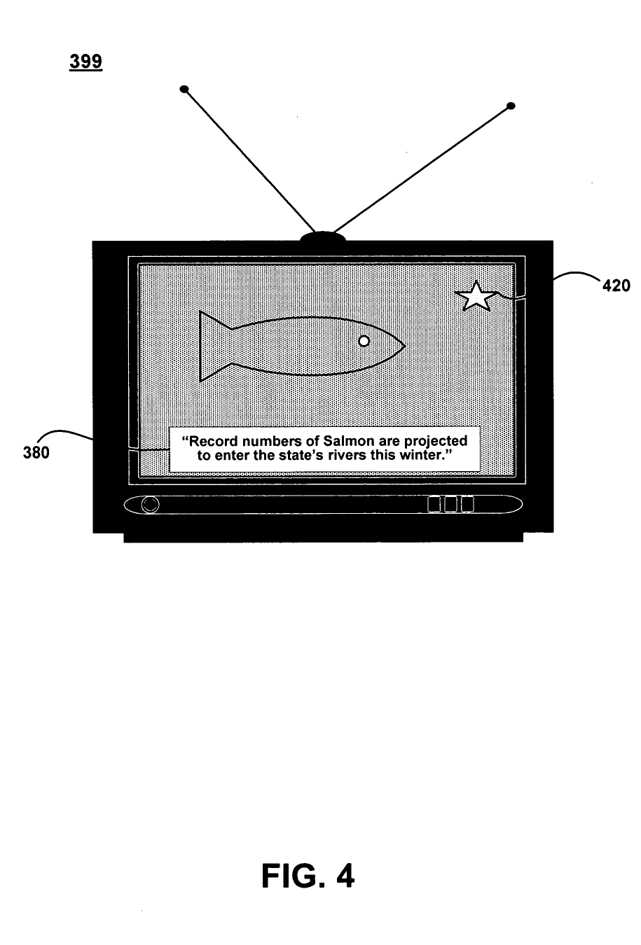

FIG. 4 is an illustration of an exemplary display device 399 displaying closed captioning data 380 in accordance with embodiments of the present technology. In one embodiment, the switch between an analog format and a digital format of closed captioning is seamless to the user. In other words, the user would not detect a difference between digitized closed captioning and analog closed captioning. This can be performed by formatting the analog format of the closed captioning to look like digitized closed captioning.

In another embodiment, the user may be alerted that the digitized format of the closed captioning is available because the digitized format of closed captioning can be user modified. In this embodiment, an icon 420, for example may be displayed to indicate that digitized closed captioning is being provided. It is appreciated that any number of methods can be used in accordance with the present technology to notify the user that different formats of closed captioning are being displayed.

### Operation

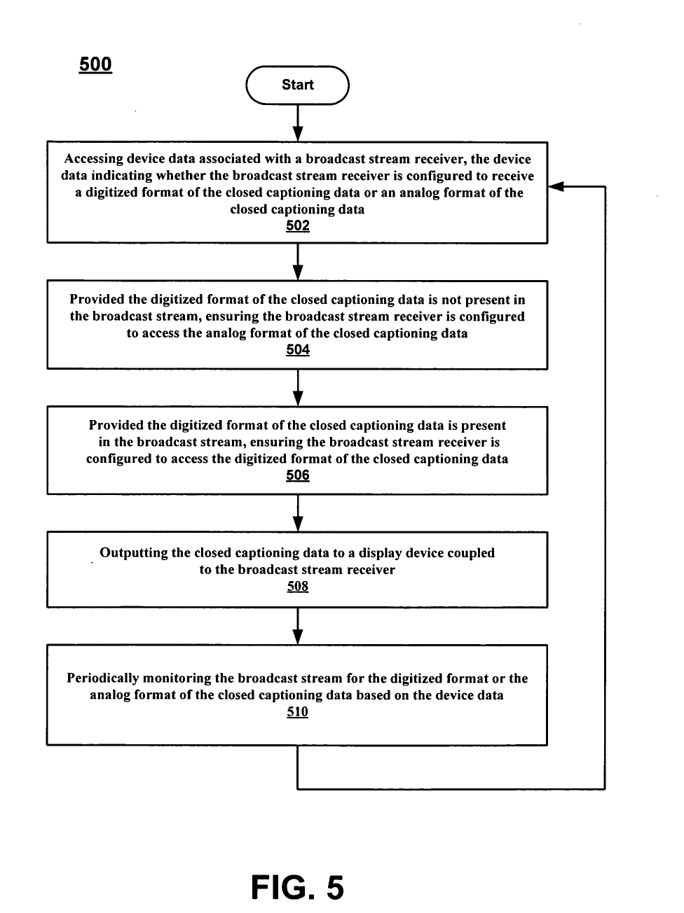

FIG. 5 is a flow diagram of an exemplary method 500 for enabling access to closed captioning data in accordance with embodiments of the present technology for enabling access to closed captioning data present in a broadcast stream.

At 502, method 500 includes accessing device data associated with a broadcast receiver wherein the device data indicates whether the broadcast receiver is configured to receive a digitized format or an analog format of closed captioning data. In one embodiment, the analog closed captioning data is formatted to the native 608 closed captioning standard and the digitized closed captioning data is formatted to the native 708 closed captioning standard.

At 504, method 500 includes provided the digitized format of the closed captioning data is not present in the broadcast signal, ensuring the broadcast stream receiver is configured to access the analog format of the closed captioning data. In one embodiment, the broadcast receiver may already be configured to receive the analog format of the closed captioning data. In response to determining the digitized format of the closed captioning data is not present in the broadcast stream, 504 includes confirming that the broadcast receiver is configured to receive the analog format of the closed captioning data.

In the case the broadcast receiver is configured to receive the digitized format of the closed captioning data and only the analog format is provided in the broadcast signal, 504 may also include automatically configuring the broadcast receiver to receive the analog format of the closed captioning data. Configuring the broadcast receiver may include modifying closed captioning preference settings on the broadcast receiver. In one embodiment, the closed captioning preference settings are modified automatically, seamlessly to the viewer.

At 506, method 500 includes provided the digitized format of the closed captioning data is present in the broadcast stream, ensuring that the broadcast receiver is configured to access the digitized format of the closed captioning data. In one embodiment, the broadcast receiver may already be configured to receive the digitized format of the closed captioning data. In response to determining the digitized format of the closed captioning data is present in the broadcast stream, 506 includes confirming that the broadcast receiver is configured to receive the digitized format of the closed captioning data.

In the case the broadcast receiver is configured to receive the analog format of the closed captioning data and the digitized format is provided in the broadcast signal, 506 may also include automatically configuring the broadcast receiver to receive the digitized format of the closed captioning data.

At 508, method 500 includes outputting the closed captioning data to a display device coupled to the broadcast stream receiver. In one embodiment, the closed captioning data is only provided to the display device when closed captioning is enabled on the broadcast receiver. When closed captioning is enabled, the digitized format of the closed captioning data is provided when present in the broadcast stream. If the digitized format is not provided, the analog format of the closed captioning data is provided.

At 510, method 500 includes periodically monitoring the broadcast stream for the digitized format or the analog format of the closed captioning data based on the device data. For example, if the device data indicates the receiver is configured to receive an analog version of the closed captioning data, 510 includes monitoring the broadcast stream for the digitized format of the closed captioning data.

Thus, the present technology provides a system and method for enabling access to closed captioning data provided in a broadcast signal. Moreover, the present technology provides a system and method for enabling access to closed captioning data provided in a broadcast signal that is able to automatically configure a broadcast receiver to receive either an analog format of the closed captioning data or a digitized format of the closed captioning data depending on which format is provided in the broadcast signal. Moreover, the present technology allows seamless switching between a digitized format and an analog format of closed captioning without requiring user configuration of the broadcast receiver.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for enabling access to closed captioning data present in a broadcast stream, said method comprising:
accessing device data associated with a broadcast stream receiver, said device data indicating whether said broadcast stream receiver is configured to receive a digitized format of said closed captioning data or an analog format of said closed captioning data; and
provided said digitized format of said closed captioning data is not present in said broadcast stream, ensuring said broadcast stream receiver is configured to access said analog format of said closed captioning data.

2. The method as described in claim 1 further comprising:
provided said digitized format of said closed captioning data is present in said broadcast stream, ensuring said broadcast stream receiver is configured to access said digitized format of said closed captioning data.

3. The method as described in claim 2 wherein said ensuring said broadcast stream receiver is configured to access said digitized format of said closed captioning data comprises configuring said broadcast stream receiver to access said digitized format of said closed captioning data.

4. The method as described in claim 1 wherein said ensuring said broadcast stream receiver is configured to access said analog format of said closed captioning data comprises configuring said broadcast stream receiver to access said analog format of said closed captioning data.

5. The method as described in claim 1 further comprising:
outputting said closed captioning data to a display device coupled to said broadcast stream receiver.

6. The method as described in claim 1 wherein said digitized format of said closed captioning data is substantially formatted to a native 708 closed captioning standard.

7. The method as described in claim 1 wherein said analog format of said closed captioning data is substantially formatted to a native 608 closed captioning standard.

8. The method as described in claim 1 further comprising:
periodically monitoring said broadcast stream for said digitized format or said analog format of said closed captioning data based on said device data.

9. A closed captioning access analyzer module configured to access closed captioning data present in a broadcast stream, said closed captioning access analyzer module comprising:
a closed captioning preference monitor configured to access device data associated with a broadcast stream receiver, said device data indicating whether said broadcast stream receiver is configured to receive a digitized format of said closed captioning data or an analog format of said closed captioning data;
a closed captioning input module for accessing said broadcast stream and for determining a format of said closed captioning data present in said broadcast stream; and
a closed captioning preference controller for ensuring said broadcast stream receiver is configured to access said analog format of said closed captioning data provided said digitized format of said closed captioning data is not present in said broadcast stream.

10. The closed captioning access analyzer module as described in claim 9 wherein said closed captioning preference controller ensures said broadcast stream receiver is configured to access said digitized format of said closed captioning data provided said digitized format of said closed captioning data is present in said broadcast stream.

11. The closed captioning access analyzer module as described in claim 9 wherein said closed captioning preference controller automatically configures said broadcast stream receiver to access said analog format of said closed captioning data provided said digitized format of said closed captioning data is not present in said broadcast stream.

12. The closed captioning access analyzer module as described in claim 9 wherein said closed captioning preference controller automatically configures said broadcast stream receiver to access said digitized format of said closed captioning data provided said digitized format of said closed captioning data is present in said broadcast stream.

13. The closed captioning access analyzer module as described in claim 9 further comprising:
an output for providing said closed captioning data to a display device coupled to said broadcast stream receiver.

14. The closed captioning access analyzer module as described in claim 9 wherein said digitized format of said closed captioning data is substantially formatted to a native 708 closed captioning standard.

15. The closed captioning access analyzer module as described in claim 9 wherein said analog format of said closed captioning data is substantially formatted to a native 608 closed captioning standard.

16. The closed captioning access analyzer module as described in claim 9 further comprising:
a closed captioning format monitor communicatively coupled to said closed captioning input module for periodically monitoring said broadcast stream for said digitized format or said analog format of said closed captioning data based on said device data accessed by said closed captioning preference monitor.

17. Instructions on a computer-usable medium wherein said instructions when executed cause a computer system to perform a method for enabling access to closed captioning data present in a broadcast stream, said computer-implemented method comprising:
accessing device data associated with a broadcast stream receiver, said device data indicating whether said broadcast stream receiver is configured to receive a digitized format of said closed captioning data or an analog format of said closed captioning data;
provided said digitized format of said closed captioning data is not present in said broadcast stream, configuring said broadcast stream receiver to access said analog format of said closed captioning data; and
provided said digitized format of said closed captioning data is present in said broadcast stream, configuring said broadcast receiver to access said digitized format of said closed captioning data.

18. The computer usable medium as described in claim 17 wherein said method further comprises:
providing said digitized format or said analog format of said closed captioning data to a display device coupled to said broadcast receiver based on whether said broadcast receiver is configured to access said digitized format or said analog format of said closed captioning data.

19. The computer usable medium as described in claim 17 wherein said method further comprises:
periodically monitoring said broadcast stream for said digitized format or said analog format of said closed captioning data based on said device data.

20. The computer usable medium as described in claim 17 wherein said method further comprises:
outputting said closed captioning data to a display device coupled to said broadcast stream receiver.
